(19) United States
(12) Patent Application Publication
(10) Pub. No.: US 2020/0309745 A1
(43) Pub. Date: Oct. 1, 2020

(54) CHROMATOGRAPHY METHOD

(71) Applicant: François PARMENTIER, St. Martin d'Heres (FR)

(72) Inventor: François PARMENTIER, St. Martin d'Heres (FR)

(21) Appl. No.: 16/754,676

(22) PCT Filed: Oct. 12, 2017
(86) PCT No.: PCT/FR2017/000192

§ 371 Date: Jun. 16, 2020

(51) Int. Cl. G01N 30/60; B01D 15/40

(52) U.S. Cl. CPC G01N 30/6078; B01D 15/40

(57) ABSTRACT

Method for exchanging materials, wherein a gaseous, liquid or supercritical mobile phase containing species to be separated is circulated through a packing comprising a stationary phase, the method being characterised in that:—the packing comprises a plurality of capillary ducts formed in at least one first material, the ducts passing through the packing between an upstream face through which the mobile phase enters the packing and a downstream face through which the mobile phase leaves the packing,—each duct comprises, on at least one portion of the inner wall thereof, at least one secondary material consisting of an organic gel or porous mineral,—the thickness of the secondary material defines, inside the duct, at least one empty tubular channel of solid material, the channel being open so as to allow the mobile phase to enter and extending continuously between the upstream and downstream faces of the capillary duct—the secondary material has a thickness between 0.05 times and 0.5 times the diameter of the channel—the method is carried out with a velocity of the mobile phase between 5.0 times and 50 times the speed of the optimum mobile phase defined by the minimum of the Van Deemter curve of the majority separating compound under the method conditions—the cumulative volume of the capillary ducts is more than 15% of the total packing volume.

### FIELD OF INVENTION

The invention concerns a chromatographic column containing a porous stationary phase

### BACKGROUND OF THE INVENTION

Chromatography is usually carried out on porous packing consisting of beds of fine particles a few micrometers or tens of micrometers in diameter. These packings have a high load loss in operation, from several tens to several hundred bar, and low productivity.

These characteristics forbid them to be used in extensive industrial purposes as a separation method.

Patent PCT US2004/032958 by Belov et al. provides an example of an embodiment attempting to solve this problem through the use of a multi-capillary filling, consisting of an assembly of parallel capillary tubes. However, the optimal operating conditions of a production method are not mentioned anywhere. The products offered in the examples are not characterized. No chromatographic separation is described.

The French patent Parmentier 14 59175 presents a new solution to the problems posed by these packings, characterized in that the walls separating the channels are made porous. This configuration gives access to very high efficiencies. However, for more rustic and less efficiency-demanding application, it may be more economical to make packings with full and mechanically very strong walls.

The invention proposes a composite packing for chromatography, comprising at least one capillary duct made in at least one first glassy material, each duct passing the packing between an upstream face through which the mobile phase enters the packing and a downstream face through which the mobile phase leaves the packing,

in which:
each duct comprises, on at least one portion of the inner wall thereof, at least one secondary material consisting of an organic gel or mineral that is porous in solvent state,
the thickness of the secondary material defines, inside the duct, at least one empty tubular channel of solid material, the channel being open so as to allow the mobile phase to enter and extending continuously between the upstream and downstream faces of the capillary duct,

### SHORT DESCRIPTION OF THE INVENTION

The invention proposes a method for exchanging materials, wherein a gaseous, liquid or supercritical mobile phase containing species to be separated is circulated through a packing comprising a stationary phase, the method being characterized in that:

the packing comprises a plurality of capillary ducts formed in at least one first material, the ducts passing through the packing between an upstream face through which the mobile phase enters the packing and a downstream face through which the mobile phase leaves the packing,

each duct comprises, on at least one portion of the inner wall thereof, at least one secondary material consisting of an organic gel or porous mineral

the thickness of the secondary material defines, inside the duct, at least one empty tubular channel of solid material, the channel being open so as to allow the mobile phase to enter and extending continuously between the upstream and downstream faces of the capillary duct,

the average diameter of the channels is less than 250 micrometers

the secondary material has a thickness between 0.05 times and 0.5 times the diameter of the channel

the method is carried out with a velocity of the mobile phase between 5.0 times and 50 times the speed of the optimum mobile phase defined by the minimum of the Van Deemter curve of the majority separating compound under the method conditions.

The cumulative volume of the capillary ducts is more than 15% of the total packing volume

Advantageously the method according to the invention is characterized in that the exchange of materials is conducted in such a way as to achieve a chromatographic separation

Advantageously the method according to the invention is characterized in that the separation of a load is conducted in a plurality of cycles

Advantageously the method according to the invention is characterized in that the method is carried out with a cycle time of less than 600 seconds, more advantageously less than 180 seconds and even more advantageously less than 30 seconds.

Advantageously the method according to the invention is characterized in that the porous secondary material has a thickness between 0.05 times and 0.25 times the diameter of the channel

Advantageously the method according to the invention is characterized in that it is carried out on a column whose ducts contain a thickness of porous materials between 0.01 times and 0.15 times the diameter of the channel, at an elution rate of between 5 times and 25 times the optimum moving phase velocity defined by the minimum of the Van Deemter curve of the majority separating compound under the method conditions.

Advantageously the method according to the invention is characterized in that the thickness of secondary material is carried on a non-porous capillary wall Advantageously the method according to the invention is characterized in that the diameter of the channels is less than 150 micrometer, preferentially less than 50 micrometer, and even more preferentially less than 15 micrometer.

Advantageously the method according to the invention is characterized in that the secondary material is a silica gel.

Advantageously the method according to the invention is characterized in that the porous material is a polymeric gel

According to a preferred embodiment of the invention, the porous secondary material is a copolymer of styrene and divinylbenzene containing Sulfonici Carboxylic radicals, aminos or quaternary ammonium.

Advantageously the porous secondary material supports a liquid stationary phase.

Advantageously, the chromatographic method is carried out in a simulated mobile bed. Advantageously the chromatographic method if carried out on continuous annular rotating apparatus.

### SHORT DESCRIPTION OF THE DRAWINGS

FIG. 1 is a cross-sectional view of a fundamental view of a cylindrical multi-capillary packing in a direction parallel to its main axis.

FIG. 2 is a cross-sectional view of a fundamental view of a cylindrical multi-capillary packing in a direction perpendicular to its main axis.’

FIG. 3 schematically describes the structure of an example of a packing duct.

FIGS. 4 and 5 explain two variants of the embodiment of a chromatographic method.

FIG. 6 shows the Van Deemter curves of multi-capillary packing

FIG. 7 shows the comparative productivity of multi-capillary packing and particulate packing.

FIG. 8 shows the comparative productivity of multi-capillary packing and particulate packing within a wide operating range.

### DETAILED DESCRIPTION OF THE INVENTION

The invention proposes a method for exchanging materials, wherein a gaseous, liquid or supercritical mobile phase containing species to be separated is circulated through a packing comprising a stationary phase, the method being characterized in that:

the packing comprises a plurality of capillary ducts formed in at least one first material, the ducts passing through the packing between an upstream face through which the mobile phase enters the packing and a downstream face through which the mobile phase leaves the packing,

each duct comprises, on at least one portion of the inner wall thereof, at least one secondary material consisting of an organic gel or porous mineral

the thickness of the secondary material defines, inside the duct, at least one empty tubular channel of solid material, the channel being open so as to allow the mobile phase to enter and extending continuously between the upstream and downstream faces of the capillary duct,

the average diameter of the channels is less than 250 micrometers

the secondary material has a thickness between 0.05 times and 0.5 times the diameter of the channel

the method is carried out with a velocity of the mobile phase between 5.0 times and 50 times the speed of the optimum mobile phase defined by the minimum of the Van Deemter curve of the majority separating compound under the method conditions.

Advantageously, the cumulative volume of the capillary ducts is more than 15% of the total packing volume.

In order to increase the number of theoretical trays of a packing for chromatography, we seek to reduce resistance to material transfer, and thus the lengths of diffusion. The aim is to work with small layers of porous material, and to work at low rate of elution.

To increase the hourly productivity of a chromatographic packing in preparatory application; or capacity, we seek instead according to the state of the art to increase the stationary phase quantity and to work at high rate of elution.

On the contrary, an optimization conducted on the capillary packing according to the invention showed that, by decreasing the thickness of the porous stationary phase layer, the gain in transfer resistance far outweighed the loss of capacity, allowing to maintain high efficiencies at very high speeds of mobile phase.

This unexpected result is the basis of this invention.

It is permitted by capillary packing, because the thickness of the stationary phase is controlled on such materials regardless of the diameter of the channels, which is not the case with particulate packing. These are limited to a single void fraction, in the range of 35 to 40%.

On the other hand, the capillary packing allows for high permeability, the pressures necessary to obtain high mobile phase speeds remain in the state of the art at reasonable costs.

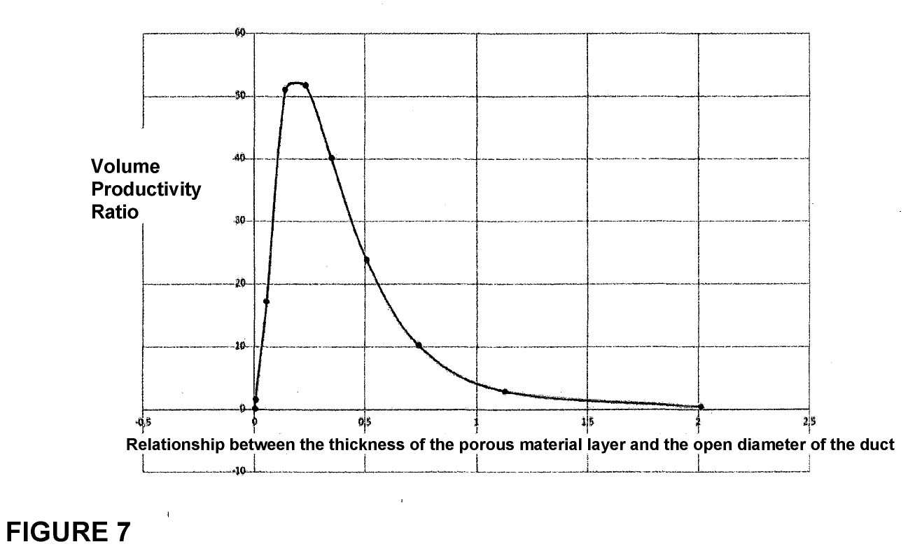

These data are particularly derived from the study conducted FIG. 7.

On the other hand, beyond a speed equal to 50 times the optimum speed of the Van Deemter curve, the loss of load of the bed becomes prohibitive.

Advantageously this method is characterized in that the exchange of materials is conducted in such a way as to achieve a chromatographic separation Advantageously all the ducts are straight, pass through the packing from side to side and leaves its upstream and downstream faces.

Advantageously the layer of porous secondary material is deposited as a separate layer of the first material and is carried on the inner periphery of the first material.

In such a packing, the capillary ducts have a substantially empty part of solid material, leaving a continuous channel extending from the upstream face to the downstream face of the packing, described in this text as part of the ducts open to the passage of the fluid or channel

The secondary material deposited on the wall of the ducts is porous.

In particular, at least the wall of the ducts has a continuous network of pores, with these pores being opened on the ducts.

The capillary ducts are advantageously straight, although it is not excluded that the ducts have bends or angles.

According to the invention, this thickness of porous secondary material has a thickness of between 0.05 times and 0.25 times the diameter of the capillary opened at the passage of fluid or channel.

Advantageously, the chromatic method that is carried out on a column whose ducts contain a thickness of porous materials between 0.01 times and 0.15 times the diameter of the duct open to the passage of fluid or channel, at an elution rate of between 5 times and 25 times the optimum moving phase velocity defined by the minimum of the Van Deemter curve

Advantageously, the diameter of the ducts opened at the passage of fluid or channel is less than 250 micrometers, preferentially less than 150 micrometers, even more preferentially less than 50 micrometers and even more preferentially less than 15 micrometers.

When the porous secondary material has different areas of thicknesses, the thickness of this material will be calculated as its average surface on the part of the duct surface it covers.

Advantageously, the multi-capillary packing according to the invention will be made with a diameter greater than 10 mm, preferably greater than 25 mm and even more preferentially greater than 50 mm.

Advantageously, the multi-capillary packing according to the invention will be made with a section greater than 1 cm², preferably greater than 5 cm² and even more preferentially greater than 20 cm² so that it can be used for preparatory use.

Advantageously, the length of the ducts is greater than 10 millimeters, preferably greater than 50 millimeters, and even more preferentially greater than 200 millimeters.

Indeed, its manufacture is simple and can be extended to any desirable diameter, several decimeters or several meters.

This important point is one aspect of the invention.

Indeed, the packings for the exchange of material could not be produced to date with channels with diameters of less than 250 microns in large dimensions.

By diameter of the capillary open to the passage of the fluid or channel, we mean the diameter or hydraulic diameter of the empty material duct in which the fluid formed by the mobile phase can flow freely and convectively.

Because of the small thickness of the porous secondary material layer, diffuse phenomena can occur with great speed. As a result, packing becomes very efficient, and accepts much higher mobile phase speeds. These two joint factors significantly increase productivity per unit of volume.

On the other hand, a multi-capillary packing has a load loss in operation 10 times less than that of a particulate packing. This significantly reduces the volume of the packing for a given separation.

Finally, the extremely short cycle time of such packing leads to “preference to split a load into a plurality of loads processed in sequence

The combination of these factors constitutes this invention.

These characteristics allow the packings of this invention to be used in preparatory chromatography, when trying to separate quantities of material free of impurities.

These quantities of material will be advantageously greater than 10 milligrams per hour, preferably greater than 1 gram per hour, and even more preferentially greater than 100 grams per hour.

Advantageously these quantities are separated into a large number of very fast injections for a discontinuous method.

Indeed, we can see in the table below (see FIG. 7) that the cycle times of a chromatographic method according to the invention are extremely short, compared to those of a particulate packing (see the line Elution Time Capillary bed/particulate bed). This is one of the aspects of the invention.

Advantageously, the load to be purified will be separated by a plurality of cycles. Following a first path of embodiment a cycle will last less than 3,600 seconds. This will particularly be the case with ion exchangers.

Advantageously for a chromatography method, each of these cycles will last less than 600 seconds, preferably less than 150 seconds, and more advantageously less than 30 seconds.

Advantageously, each of these cycles will last more than 3 seconds, advantageously more than 10 seconds. This extends the life of the control organs.

In the case of a cyclical method, the cycle time is the time between two load injections.

In the case of a method carried out on a continuous annular chromatograph, the cycle time will represent the time taken by a packing revolution.

In the case of a simulated mobile bed, the cycle time will be taken as the dwell time of the mobile phase in the sum of the elementary packing constituting the method.

These packings will have an advantageous volume of greater than 1 cm³, preferably greater than 100 cm³, and even more preferentially greater than 1 liter.

In the case of this invention, the Van Deemter curve will be measured under high dilution conditions, in order to be as much as possible in the field of linear chromatography.

Advantageously, the dilution of the species on which the Van Deemter curve will be measured will have a concentration in the sample to be separated less than 5% in mole, more advantageously less than 5 per thousand in mole, and even more advantageously less than 500 parts per million in mole.

Advantageously, the Van Deemter curve will be taken to determine the majority molar fraction species among the species to be separated.

By method conditions we mean that the Van Deemter curve is measured with the same stationary phase, at the same temperature and with the same elution solvents as the method, possibly with the same gradients of elution of the mobile phase, and the same temperature gradients for the column, on a column with the same length as that of the method.

Advantageously, the Van Deemter curve can be measured on a standard column of 4.6 mm in diameter.

It is well known that the performance in terms of the number of theoretical plateaus of the chromatographic method varies little with the diameter of the column in the current state of the art.

It will therefore be possible to extrapolate to a column of larger diameter the performances obtained on a column of analytical diameter, easier to achieve and to operate.

Advantageously, the porous secondary material has a porous volume between 0.15 and 0.95 cm³/cm³ of material.

More advantageously, the porous secondary material has a porous volume between 0.3 and 0.80 cm³/cm³ of material.

Advantageously, the chromatic method that is carried out on a column containing a thickness of porous secondary materials between 0.01 times and 0.25 times the diameter of the capillary open to the passage of fluid or channel, at an elution rate of between 2 times and 25 times the optimum moving phase velocity defined by the minimum of the Van Deemter curve.

Preferentially, the chromatic method that is carried out on a column containing a thickness of porous secondary materials between 0.01 times and 0.15 times the diameter of the capillary open to the passage of fluid or channel, at an elution rate of between 5 times and 25 times the optimum moving phase velocity defined by the minimum of the Van Deemter curve.

More preferentially, the chromatic method that is carried out on a column containing a thickness of porous secondary materials between 0.01 times and 0.10 times the diameter of the capillary open to the passage of fluid or channel, at an elution rate of between 5 times and 50 times the optimum moving phase velocity defined by the minimum of the Van Deemter curve.

Advantageously, the thickness of porous secondary material is carried on a capillary wall in the first non-porous material.

According to another path of embodiment, the thickness of porous secondary material is carried on a capillary wall in the first porous material.

Advantageously, the diameter of the ducts opened at the passage of fluid or channels is less than 500 micrometers, preferably less than 250 micrometers, even more preferentially less than 50 micrometers.

According to a preferred embodiment, the diameter of the ducts opened at the passage of fluid or channels is less than 15 micrometers.

According to a preferred embodiment of the invention, the porous secondary material is a silica gel for chromatography.

Advantageously, the specific surface of the porous secondary material is between 50 and 800 m²/g, and preferably between 70 and 600 m²/g.

Advantageously, the specific surface will be measured by nitrogen adsorption on the porous material.

The velocity of the mobile phase is defined as the empty speed or surface velocity, that is, the speed the fluid would have if it flowed regularly over the entire section of the packing.

The capillary ducts are advantageously straight, although it is not excluded that the ducts have bends or angles.

The capillary ducts have a uniform section in relation to each other and on their length.

Section variability of ducts will be conveniently defined by a relative standard deviation. This relative standard deviation represents the ratio of the standard deviation of the diameter of the ducts to the average diameter of the ducts, expressed as a percentage. Advantageously the ducts present in the first material have a substantially constant average diameter from one duct to another, such that the standard deviation of the diameter on the sample of ducts of the packing does not exceed 10% of the average diameter, preferably does not exceed 2% of the average diameter, and even more preferentially does not exceed 1.0% of the average diameter. In this text, the average of a set of values of a variable X is defined as its arithmetic average E[X]. The standard deviation is defined as the square root of the arithmetic average of (X−E[X)². In this text distribution is understood as a set of variable X values.

Advantageously the diameter of the duct does not vary by more than 10% over the length of the same duct.

Advantageously, this diameter preferably does not vary by more than 2% over the length of the same duct. Even more advantageously the diameter does not vary by more than 1% over the length of the same duct.

Advantageously the diameter ducts open on the passage of fluid or the channels present in the first material have a substantially constant average diameter from one duct to another, such that the standard deviation of the diameter on the sample of ducts of the packing does not exceed 10% of the average diameter, preferably does not exceed 2% of the average diameter, and even more preferentially does not exceed 1.0% of the average diameter.

Advantageously, the ducts pass through the packing from side to side, thus minimizing the load loss within the packing during the chromatographic separation process.

Advantageously, the cumulative volume of ducts opened at the passage of fluid or channels represents more than 5% of the total volume of the packing, preferably more than 15% of the said total volume and even more preferable more than 50% of the total volume of the packing. In this text, “total volume of the packing” is understood as the volume occupied by the packing, including its porosity and ducts, the said total volume can therefore be calculated from the external dimensions of the said packing. The volume of the channels is measured as follows: number of channels×average section of a duct open to the passage of fluid or channel×average length of a channel.

The volume of secondary material is calculated by the formula: number of ducts×average section of the stationary phase in a duct×average length of a duct.

Advantageously, the volume of capillary ducts represents more than 5% of the total volume of the packing, preferably more than 15% of the said total volume and even more preferable more than 50% of the total volume of the packing. The volume of the ducts is measured as follows: number of channels×average section of a duct×average length of a duct. By duct we mean the duct comprising the channel and the porous secondary material.

Advantageously, the volume occupied by the porous secondary material in the packing is more than 2% of the volume of the packing excluding the ducts, preferably more than 5% of that volume and even more preferably more than 10% of that volume. “Volume of packing to the exclusion of ducts” means the difference between the total volume of the packing and the volume of the part of the capillaries open to the passage of fluid or channels.

The ducts may have a section of any appropriate shape, for example a circular, square, rectangular, hexagonal, star-shaped, slit-shaped, etc. When the ducts have a non-circular section, the “diameter” of the pipes is defined as their hydraulic diameter.

In particular the ducts have a circular section.

In particular the ducts have a regular hexagonal shape section.

In particular the ducts have a flat or slit shape bounded by two parallel planes.

Advantageously, the ducts have a hydraulic diameter of 250 μm or less. Depending on a method of embodiment, the hydraulic diameter of the ducts is less than or equal to 50 μm or even less than 15 μm. The hydraulic diameter is classically calculated as equal to four times the section of a duct (in m²) divided by the perimeter of the said pipe wetted by the mobile phase (in m).

Finally, the relative standard deviation of the thickness of porous secondary material on a section of the packing is preferably less than 10%, even more preferentially less than 5%, and even more preferentially less than 2.0%. In this case, the relative standard deviation characterizes the ratio between the standard deviation of porous material thickness and its average, expressed in %.

The porosity of the material can be advantageously defined in chromatography in three ways:
1. The porosity of an organic gel may come from the swelling of a reticulated gel in an organic, mineral or aqueous solvent, swelling that is advantageously more than 2% of its volume, and preferably more than 10% of its volume.
2. It may come from a porosity of the material in the non-solvent state.
3. It may come from the porosity of a support on which a gel is deposited in the form of a thin layer

According to the invention, the porous volume includes the cumulative volume of micropores, mesopores and macropores.

By porosity of the material we mean the porosity of the secondary material to the exclusion of the volume of the ducts opened at the passage of the fluid or channels.

Advantageously, the porosity of the secondary material will be measured in the desolvented dry state.

“Mesopores” means pores between 2 and 50 nanometers in diameter; “macropores” refers to pores with a diameter greater than 50 nanometers; “micropores” means pores with a diameter of less than 2 nanometers.

The pore sizes mentioned in this text are measured using two different techniques depending on the nature of the material being tested: when it is a mineral material and in particular silica, the technique used is mercury porosimetry for macro and mesoporosity, and nitrogen adsorption for microporosity; when it comes to polymeric materials or mineral matrices covered with organic gels, mercury porosimetry is used for macroporosity and nitrogen adsorption porosimetry for mesoporosity and microporosity.

The invention is described in more detail in the drawings described below.

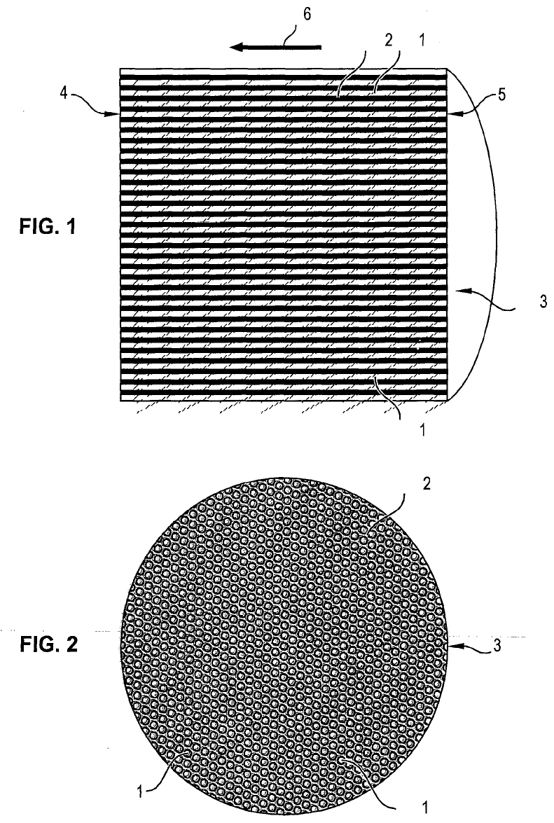

In the example shown in FIG. 1, the capillary ducts are straight, parallel, and spaced evenly. The different ducts have as identical morphologies and diameters as possible. Each duct passes through the packing from side to side, i.e. it advantageously has its open ends on each side 4 and 5 of the packing, allowing the fluid to flow from the entry side 4 to the exit side 5.

Such packing can therefore be used in a chromatographic column.

FIG. 2 is a top view of the face 5 of the packing of FIG. 1 seen in direction 6. The openings of individual capillary ducts 1 can be distinguished in organic gel mass 2.

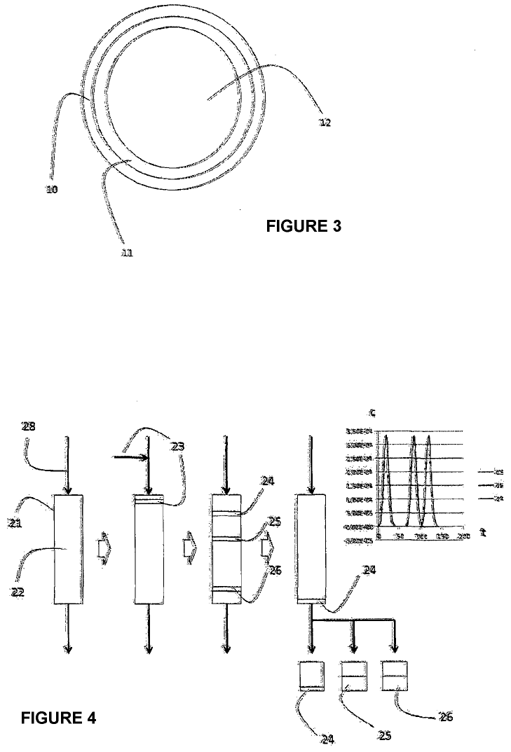

According to a method of embodiment, the wall of the ducts 10 is made up of a solid continuum into a first material supporting the porous secondary material 11 (FIG. 3) on its inner periphery. The part of the ducts opened at the passage of a fluid is made up by the central passage of the capillary 12 or channel. The duct can have a circular or hexagonal section.

According to this method of embodiment, the duct wall may be made up of a first non-porous material, the said material being chosen from:
glass
silica
a silicoaluminate like cordierite
stainless steel
an organic polymer such as polypropylene, polyethylene, PEEK, Polytetrafluoroethylene or PTFE, polyvinylidene fluoride or PVDF.

Following another method of embodiment, the wall of the ducts is made up of one of the materials on this list to which porosity is conferred.

Advantageously the gel constituting the stationary phase is the porous secondary material and is a mineral gel

According to a method of embodiment, the gel made up of a mineral species is chosen from:
silica gel
activated alumina
titanium oxide
zirconium oxide

Advantageously the gel constituting the stationary phase is the porous secondary material and is a mineral gel made up of silica gel

Advantageously the gel constituting the stationary phase is the porous secondary material and is an organic gel. We will consult French application No. 14 59175 by F. Parmentier for a description of the organic gels that can be used for this invention.

An extremely simple process for packing according to the invention consists of departing from a macroscopic capillary tube to a stretchable material, such as a glass, polymer or metal. This tube is stretched to the desired diameter, possibly while hot to fluidize the material. Diameters of 0.2 m can thus be obtained.

It is covered internally with a homogeneous stationary phase film by pushing a cap of a liquid precursor throughout the length of the tube. A film is deposited, in which porosity is developed through polymerization with a reticulating agent in the presence of a solvent and drying through dissolution, or by drying.

Tubes from the previous process are cut into sections of the same size and are assembled in parallel and possibly glued together tightly. They can be inserted into a pressure-resistant structure and equipped with fluid input and output organs such as sintered dispensers and standard-type connections.

Chromatography is a particular molecular separation method characterized in that it separates a mixture of chemicals under contradictory action
dynamic training of these species by a current of an eluent phase
retention of these species through a stationary phase.

Preferably this method is continued until the separate species are completely eluted out of the stationary phase.

There are two general categories of chromatographic method, elution chromatography and affinity chromatography.

FIG. 4 describes a an elution chromatography method. According to this method, a continuous flow of mobile phase 28 of composition and temperature possibly variable over time passes through the chromatography column 21 filled with a stationary phase 22. A load volume to be separated 23 is injected into the feed stream. Under the antagonistic effect of reversible retention of chemical species by the stationary phase and elution or training by the mobile phase, species migrate at different speeds along column 21 and separate into elution bands or peaks 24, 25, 26, etc.

Separate species are isolated by splitting the flow out of the column to collect each band at the time of its exit from the column in the elution solvent.

This splitting may be temporal in the case of a discontinuous or angular method in the case of a continuous annular device. It can consist of the separation of a head fraction and a tail fraction for a device in a simulated mobile bed.

The chromatogram represents the peaks of concentration of species 24, 25, 26 in column output depending on time.

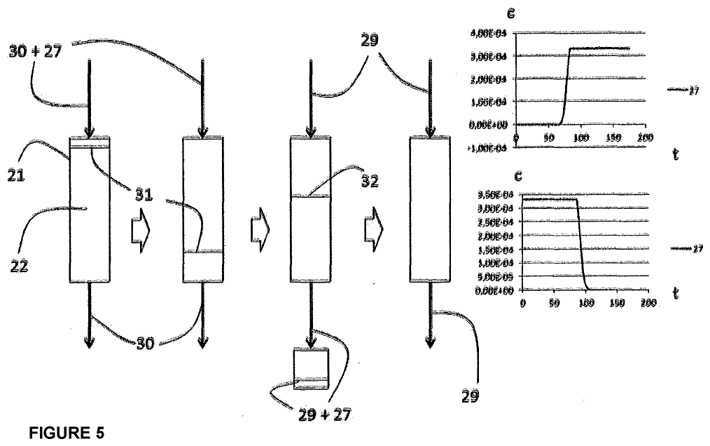

FIG. 5 describes an affinity chromatography method that separates molecules, ions or biomolecules. A continuous stream of solvent 30 containing the molecule to be separated 27 feeds the chromatography column 21 filled with a stationary phase 22 presenting a strong affinity for the molecule to be separated. Under the effect of this strong affinity the molecule attaches itself to the stationary phase continuously until the saturation thereof. This binding is almost irreversible under the conditions of this first phase. The progression front 31 of the concentration in 27 is in this case a slit progressing towards the exit. The column is saturated when the concentration in 27 becomes significant in the solvent coming out of the column.

In a second phase, the properties (pH, ionic strength, etc.) or the nature of the elution solvent 29 are changed to decrease or eliminate the affinity of molecule 27 for the stationary phase 22, and to solubilize the molecule in the solvent 29. The molecule 27 is eluded in solvent 29 coming out of column 21 until the amount present in it is exhausted. Column 21 is then regenerated and ready for a new cycle.

The chromatograms represent the concentration profiles of the species 27 in column output depending on time, during the binding and then elution phases.

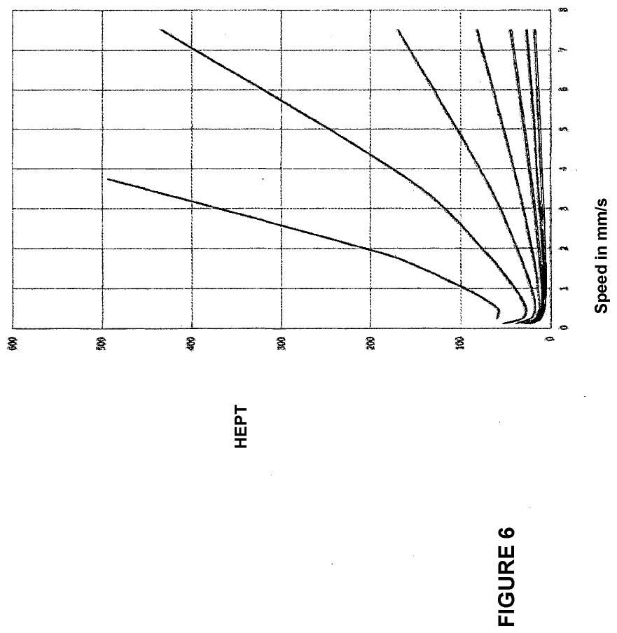

FIG. 6 depicts the Van Deemter curves of a multi-capillary packing with varying thicknesses of a porous stationary phase on the inner periphery of its ducts according to the layout described in FIG. 3. A Van Deemter curve connects behavior in efficiency translated into a theoretical plateau height of chromatographic packing, at the speed of the mobile phase for an elution chromatography. We find that these Van Deemter curves have a minimum or [where] the efficiency is the best. On the X axis, the stationary phase speeds are given in mm/s measured on the section of the duct including the thickness of porous material. On the Y axis, the heights of theoretical trays in micron are reported. It is observed that at high speed the Van Deemter curves become more parallel to the X axis the thinner the stationary phase is deposited on the wall. This fact is a distinctive feature of the invention, and leads to being able to work at higher speed and therefore with higher bed productivity while maintaining a higher efficiency than with particulate beds. These curves are given for a circular section duct diameter open to the passage of fluid or channel of 10 micrometers. The seven curves in FIG. 6 correspond from top to bottom to porous material thickness covering the entire duct wall and equal to, from left to right, in micrometers:

TABLE 1

| | 10.1 | 5.6 | 3.7 | 2.5 | 1.7 | | 1.1 | | 0.7 | |
|---|---|---|---|---|---|---|---|---|---|---|
| Ratio of Porous material | 1.0057 | 0.5647 | 0.3693 | 0.2529 | 0.1734 | 0.1147 | 0.0691 | 0.0270 | 0.0025 | 0.0003 |
| thickness/open duct diameter | | | | | | | | | | |
| Vacuum fraction | 0.8897 | 0.7795 | 0.6692 | 0.5589 | 0.4487 | 0.3384 | 0.2281 | 0.1000 | 0.0100 | 0.0010 |
| open to convection | | | | | | | | | | |
| Reduced height | 6.6664 | 3.0252 | 1.8004 | 1.2461 | 0.9617 | 0.8057 | 0.7191 | 0.5632 | 0.5036 | 0.4983 |
| Reduced speed | 0.8779 | 1.7558 | 2.6337 | 3.5116 | 4.3896 | 5.2675 | 6.1454 | 7.1656 | 7.8822 | 7.9538 |
| Capillary diameter/ | 0.2404 | 0.2290 | 0.2164 | 0.2079 | 0.2042 | 0.2047 | 0.2089 | 0.1997 | 0.1980 | 0.1978 |
| Particle diameter | | | | | | | | | | |
| Capillary Bed Length/ | 0.6678 | 0.2887 | 0.1623 | 0.1079 | 0.0818 | 0.0687 | 0.0626 | 0.0469 | 0.0415 | 0.0411 |
| Particulate Bed | | | | | | | | | | |
| Length | | | | | | | | | | |
| Surface speed capillary | 0.1491 | 0.6261 | 1.4911 | 2.7594 | 4.3897 | 6.3045 | 8.4089 | 11.9635 | 14.5964 | 14.8747 |
| bed/particulate | | | | | | | | | | |
| bed | | | | | | | | | | |
| Elution time capillary | 4.4781 | 0.4611 | 0.1089 | 0.0391 | 0.0186 | 0.0109 | 0.0074 | 0.0039 | 0.0028 | 0.0028 |
| bed/particulate | | | | | | | | | | |
| bed | | | | | | | | | | |
| Volume capillary | 0.2233 | 2.1687 | 9.1845 | 25.5650 | 53.6488 | 91.7356 | 134.3220 | 255.3355 | 351.3127 | 362.1200 |
| bed/particulate bed | | | | | | | | | | |
| Volume productivity | 0.3311 | 2.8174 | 10.2438 | 23.8154 | 40.1179 | 51.7399 | 51.0740 | 42.5559 | 5.8552 | 0.6035 |

FIG. 7 shows the productivity ratio compared per column volume unit between a multi-capillary packing according to the invention and a particulate packing. This comparison is made conveniently at the minimum of the Van Deemter curve. The comparison is made for an identical column load loss and an identical number of trays between the two packings. It is observed that this curve presents a very highly charged maximum for the low thicknesses of stationary phase on the tube wall, between 0.005 and 1.0 times the hydraulic radius of the free duct at the passage of the fluid. The multi-capillary packing is up to 50 times more productive in these conditions than particulate packing.

Volume productivity is calculated as the mobile phase flow passing through the packing per unit of volume reduced to the amount of porous material present in that volume.

The previous table 1 shows the characteristic sizes leading to the curve in FIG. 7.

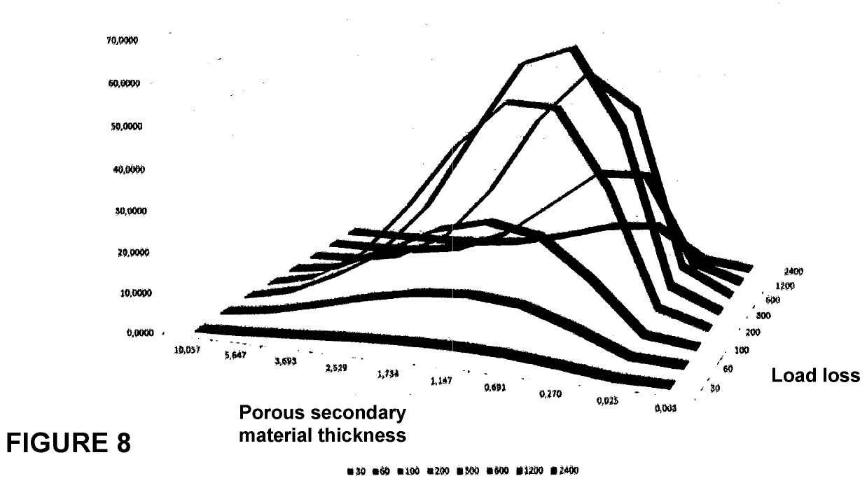

FIG. 8 shows the same ratio as FIG. 7 in a wider range of operating conditions. The different curves or bands represent for a given adimensional load loss (30 to 2,400, optimum Van Deemter curve for the value of 200), the productivity ratio compared per column volume unit for porous material thicknesses ranging from 10.057 μm to 0.003 μm (diameter of the open duct at the passage of the fluid or channel equal to 10 μm).

The following Table 2 can be used to find gain factors to apply to the given ratios in FIG. 8 when the reference speed (or load loss) of the particulate bed increases.

The comparison is all the more favorable to packing according to the invention if the particulate bed is operated at high elution speed.

TABLE 2

| Load loss | Factor |
|---|---|
| 200 | 1 |
| 300 | 1.3691427 |
| 600 | 3.88484339 |
| 1,200 | 16.1266904 |
| 2,400 | 88.3237398 |

Advantageously, the invention uses an elution chromatography method.

Elution chromatography can be conducted through any known technique, such as discontinuous column chromatography, radial or axial continuous annular chromatography, the simulated mobile bed.

Advantageously, the chromatographic method implemented may be an affinity chromatography method.

Advantageously, the chromatographic method implemented may be an ion exchange method.

In particular the porous material can be created using a sol-gel process.

Without going outside the framework of the invention, this sol-gel process can also be based on an aluminosilicate such as a clay for example.

Advantageously the porous material of the packings according to the invention will consist of silica gel.

Advantageously, this gel will be deposited on the wall of the ducts by soaking in the form of a liquid precursor.

Liquid precursor refers to any liquid leading to a silica gel under the conditions of the manufacturing process, such as alkaline silicate in a water solution, silica sol, hydrolysable alkoxysilane.

This deposit can be made by soaking or wetting the inner wall of the ducts in order to produce a liquid film of the precursor, discharge and drain the excess liquid, and acidification, hydrolysis, drying or calcination of the deposit.

It can also be achieved by chemical deposit in the steam phase by, for example, having gaseous hydrofluoric acid act on a pure silica wall.

It can be modified by any known surface treatment, such as silanization by octadecyltrialkoxysilane, octyltrialkoxysilane, aminopropyltrialkoxysilane, etc.

Examples of such treatments for silica gels and organic gels can be found in the reference [1].

### Example of Embodiment No. 1

A PEEK capillary tube of 150 μm in external diameter and 100 μm in internal diameter is stretched while hot to obtain a tube of 50 μm in internal diameter.

100,000 of these fibers are assembled into a 300 mm long beam and their outer surfaces are glued by an epoxy resin without closing up their ends. The beam is inserted and glued into a glass tube about 300 mm long and about 30 mm in diameter.

The ducts are covered by soaking a thin layer of a styrene mixture (91.6% by weight), 8% by weight of divinylbenzene, and 0.4% by weight of a polymerization activator (azobisisobutyronitrile). The layer is deposited by pushing a liquid cap of this mixture into the beam under a light stream of nitrogen.

It is placed for 24 hours at 70° C. under nitrogen.

The resulting monolith is converted into a basic ion exchanger by subjecting it to the action of a current of a solution at 15% by weight of tin tetrachloride in the chlorodimethylic ether at 0° C. for 6 hours. The packing is then washed with methanol and then with water and quaternized by the action of a current of a 40% trimethylamine water solution over a period of ten hours. The packing is then washed to neutrality and the quaternary ammonium is converted into its hydroxylated form.

### Example of Embodiment No. 2

A PEEK capillary tube of 150 μm in external diameter and 100 μm in internal diameter is stretched while hot to obtain a tube of 50 μm in internal diameter.

A mixture containing 8 g of hydroxyethyl methacrylate, 32 g of divinylbenzene, 445 mg of azobisisobutyronitrile, 60 g of dodecanoyl is prepared and degassed under nitrogen for 20 minutes.

A fraction of this mixture is injected into the previous tube and pushed at constant speed with a slow flow of nitrogen to obtain a thickness of 10 m on the tube wall.

This tube is raised to 70° C. for 24 hours. The mixture polymerizes.

The polymer thus created is washed causing the THF to percolate for 30 minutes and dried in the oven at 90° C.

100,000 fibers obtained by cutting one or more of the tubes thus made into equal sections are assembled in a 300 mm long beam and their outer surfaces are glued by an epoxy resin without closing off their ends. The beam is inserted and glued into a glass tube about 300 mm long and about 30 mm in diameter.

### Example of Embodiment No. 3

200 g of Silica Gel for chromatography with pore sizes of 4 nm (SiliCycle ref R10030 A) are crushed to an average particle diameter of about 3 m.

The powder is gradually suspended in 500 ml of a 200 ml mixture of 30% dry matter Grace sol silica HS30 and 300 ml of demineralized water.

A 25 mm diameter glass bar containing 100,000 ducts of 50 μm in diameter is made and treated as follows:

A borosilicate glass capillary of 75 μm in external diameter and 50 μm in internal diameter is produced, cut into lengths of 40 cm and 100,000 of these fibers are assembled in a beam, glued together in the shape of a bar 30 mm in diameter by an epoxy resin, and inserted into a glass tube.

The ducts are covered on their inner wall by soaking a thin layer of the previous silica and sol silica mixture. The layer is deposited by pushing a liquid cap of this mixture into the beam under a light stream of nitrogen so as to deposit a layer of silica of 5 μm on the beam wall.

The beam is air-dried at 105° C. for two hours.

### Example of Embodiment No. 4

The beam obtained in example No. 3 above is encapsulated in a chromatographic column. A separation test is carried out along with it under the following conditions:

Mobile phase: methanol 95 volume per volume/water 5 volume per volume. Feed flow 3.3 ml/mn
The Van Deemter curve measured shows a minimum of 0.33 ml/mn
Sample portion: benzylic alcohol 100 ppm by weight in methanol, benzaldehyde 5 ppm by weight in methanol, trimethylamine 5 ppm by weight in methanol.
The column has a theoretical plateau number of 5,200 at least in the Van Deemter curve and 1,230 for 3.3 ml/mn.

### Example of Embodiment No. 5

The beam obtained in example No. 3 above is encapsulated in a chromatographic column. A separation test is carried out along with it under the following conditions:

Mobile phase: cyclohexane 98 volume per volume/ethyl acetate 2 volume per volume. Feed flow 2.4 ml/mn
The Van Deemter curve measured shows a minimum of 0.24 ml/mn
Sample portion: 2 phenyl phenol 50 ppm by weight in cyclohexane, 2-ter butyl phenol 50 ppm by weight in cyclohexane.
The column has a theoretical plateau number of 4,800 at least in the Van Deemter curve and 1,050 for 2.4 ml/mn.

### REFERENCES

[1] Liquid and supercritical phase chromatographies, R. Rosset, M. Caudë, A. Jardy, MASSON 3^{rd} edition, 1991

1. A method for exchanging materials, wherein a gaseous, liquid, or supercritical mobile phase containing species to be separated is circulated through a packing comprising a stationary phase, the method being characterized in that:
the packing comprises a plurality of capillary ducts formed in at least one first material, the ducts passing through the packing between an upstream face through which the mobile phase enters the packing and a downstream face through which the mobile phase leaves the packing;
each duct comprises, on at least one portion of the inner wall thereof, at least one secondary material consisting of an organic gel or porous mineral;
a thickness of the secondary material defines, inside the duct, at least one empty tubular channel of solid material, the channel being open so as to allow the mobile phase to enter and extending continuously between the upstream and downstream faces of the capillary ducts;
the thickness of the secondary material being between 0.05 times and 0.5 times a diameter of the channel;
the method is carried out with a velocity of the mobile phase between 5.0 times and 50 times a speed of an optimum mobile phase defined by the minimum of the Van Deemter curve of a majority separating compound under the method conditions; and
the cumulative volume of the capillary ducts is more than 15% of a total packing volume.

2. The method of claim 1, wherein the exchange of materials is conducted in such a way as to achieve a chromatographic separation.

3. The method of claim 21, wherein the exchange of materials is conducted in a plurality of cycles.

4. The method of claim 3 wherein the method is carried out with a cycle time of less than 600 seconds.

5. The method of claim 1, wherein the secondary material has a thickness between 0.05 times and 0.25 times the diameter of the channel.

6. The method of claim 1, wherein the secondary material has a thickness between 0.01 times and 0.15 times the diameter of the channel, and the velocity of the mobile phase is between 5 times and 25 times the optimum moving phase speed.

7. (canceled)

8. The method of claim 1, wherein the diameter of the channel is less than 150 micrometers.

9. The method of claim 1, wherein the secondary material is a silica gel.

10. The method of claim 1, wherein the secondary material is a polymeric gel.

11. The method of claim 3, wherein the method is carried out with a cycle time of less than 180 seconds.

12. The method of claim 3, wherein the method is carried out with a cycle time of less than 30 seconds.

13. The method of claim 1, wherein the diameter of the channel is less than 50 micrometers.

14. The method of claim 1, wherein the diameter of the channel is less than 15 micrometers.
